(19) United States
(12) Patent Application Publication
(10) Pub. No.: US 2009/0183068 A1
(43) Pub. Date: Jul. 16, 2009

(54) ADAPTIVE COLUMN RENDERING

(75) Inventor: Henrik Bard, Lund (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/013,596

(22) Filed: Jan. 14, 2008

(51) Int. Cl. G06F 17/00

(52) U.S. Cl. 715/252

(57) ABSTRACT

A system and method for rendering web page column widths in an adaptive manner for display on an electronic device. The system and method can display individual columns of a web page in a zoom-in view and can display web pages with multiple columns in a zoom-out view. Columns are adaptively rendered such that text in the columns is readable after zooming-in on the column. The system and method avoids the need for side-to-side scrolling of a column displayed in a zoom-in view and minimizes column narrowing.

### TECHNICAL FIELD OF THE INVENTION

The present disclosure relates generally to displaying web page content on mobile devices and, more particularly, to a system and method for rendering web page column widths in an adaptive manner.

### BACKGROUND

Mobile and/or wireless electronic devices are becoming increasingly popular. For example, mobile telephones, portable media players and portable gaming devices are now in wide-spread use. In addition, the features associated with certain types of electronic devices have become increasingly diverse. To name a few examples, many electronic devices have cameras, text messaging capability, internet browsing capability, electronic mail capability, video playback capability, audio playback capability, image display capability, and handsfree headset interfaces.

The portable nature of mobile electronic devices may limit the area available for display devices. Typically, display devices utilized in mobile electronic devices are significantly smaller than the displays of their non-portable counterparts. Thus, receiving and displaying web page content in its native or original form on mobile electronic devices may result in unreadable content. For example, if viewed in its entirety in a zoomed-out mode on a small screen, text in a web page will likely be too small to be readable. If viewed in a zoomed-in mode, where only a portion of the web page is viewable on the display, the text size will be larger and more readable, but the user may have to scroll side-to-side and up-and-down in order to see all of the content. For large web pages, this process may be very cumbersome.

To address the side-to-side scrolling issue, electronic devices with small screens may render the columns of a web page to be narrower and consequently longer than the original page, such that when the electronic device zooms in on the column to make the text readable, the column width fits the screen width. In this manner, a user viewing the column in a zoomed-in mode may only have to scroll up-and-down to see all of the content. These electronic devices may have a fixed zoom factor, for example, three times (3×), which in some instances may result in text that is unnecessarily large or still too small to read. As a consequence, when the zoomed-in text of a column is unnecessarily large, the column width has also been made unnecessarily narrow and long. When viewed in the zoomed-out mode, this may also create excessive white space adjacent to the column. White space may occur if the text width in a column is narrower than another component of the web page content in that column, for example, an image or table with a fixed width.

### SUMMARY

To improve the appearance and readability of web page content on an electronic device, there is a need in the art for a system and method for rendering web page column widths in an adaptive manner.

To enhance the appearance and readability of web page content on an electronic device, the present disclosure describes an improved device and method for displaying individual columns of a web page in a zoom-in view and displaying web pages with multiple columns in a zoom-out view that better preserves the original layout of the web page.

According to one aspect of the invention, a method for displaying web page content on an electronic device, the web page content including at least one column of text, including calculating a zoom factor for the at least one column; determining a text size in the at least one column based on the zoom factor; comparing the determined text size to a reference text size; and changing a column width of the at least one column if the determined text size is less than the reference text size.

According to an embodiment of the method, changing the column width of the at least one column includes narrowing the column width until the determined text size is greater than or equal to the reference text size, including re-calculating the zoom factor for the at least one column; re-determining the text size in the at least one column based on the zoom factor; and re-comparing the determined text size to the reference text size.

According to an embodiment of the method, determining the text size in the at least one column based on the zoom factor includes searching for a smallest font in the at least one column of text and using the smallest font to determine the text size.

According to an embodiment, the method further includes displaying the web page content in a zoomed-out view, wherein a plurality of columns of text are viewable on a screen of the electronic device.

According to an embodiment, the method further includes displaying the at least one column of text in a zoomed-in view based on the zoom factor.

According to an embodiment of the method, the screen is a display of a mobile radio terminal.

According to another aspect of the invention, a program that displays web page content on an electronic device, the web page content including at least one column of text, and is embodied on a computer-readable medium, the program including executable logic to calculate a zoom factor for the at least one column; determine a text size in the at least one column based on the zoom factor; compare the determined text size to a reference text size; and change a column width of the at least one column if the determined text size is less than the reference text size.

According to another aspect of the invention, a mobile radio terminal, including a radio circuit for establishing calls; and a control circuit that carries out logical instructions to display web page content on a display of the mobile radio terminal, the web page content including at least one column of text, the control circuit including logic that calculates a zoom factor for the at least one column; logic that determines a text size in the at least one column based on the zoom factor; logic that compares the determined text size to a reference text size; and logic that changes a column width of the at least one column if the determined text size is less than the reference text size.

According to an embodiment of the mobile radio terminal, logic that changes the column width of the at least one column includes logic that narrows the column width until the determined text size is greater than or equal to the reference text size, including logic that re-calculates the zoom factor for the at least one column; logic that re-determines the text size in the at least one column based on the zoom factor; and logic that re-compares the determined text size to the reference text size.

According to an embodiment of the mobile radio terminal, logic that determines the text size in the at least one column based on the zoom factor includes logic that searches for a smallest font in the at least one column of text and logic that uses the smallest font to determine the text size.

According to an embodiment of the mobile radio terminal, the control circuit further includes logic that displays the web page content in a zoomed-out view, wherein a plurality of columns of text are viewable on the display of the mobile radio terminal.

According to an embodiment of the mobile radio terminal, the control circuit further includes logic that displays the at least one column of text in a zoomed-in view based on the zoom factor.

These and further features will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the scope of the claims appended hereto.

Features that are described and/or illustrated with respect to one embodiment may be used in the same way or in a similar way in one or more other embodiments and/or in combination with or instead of the features of the other embodiments.

The terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1 is a schematic view of a mobile telephone as an exemplary electronic device that includes a display;

FIG. 2 is a schematic block diagram of the mobile telephone of FIG. 1;

FIG. 3 is a schematic diagram of a communications system in which the mobile telephone of FIG. 1 may operate;

FIG. 4 shows exemplary displays of web page content on an electronic device; and

FIG. 5 is a flow chart representing an exemplary method of adaptive column rendering using the mobile telephone of FIG. 1.

### DETAILED DESCRIPTION OF EMBODIMENTS

Embodiments will now be described with reference to the drawings, wherein like reference numerals are used to refer to like elements throughout. It will be understood that the figures are not necessarily to scale.

The interchangeable terms “electronic equipment” and “electronic device” include portable radio communication equipment. The term “portable radio communication equipment,” which hereinafter is referred to as a “mobile radio terminal,” includes all equipment such as mobile telephones, pagers, communicators, electronic organizers, personal digital assistants (PDAs), smartphones, portable communication apparatus or the like.

In the present document, embodiments are described primarily in the context of a mobile telephone. It will be appreciated, however, that the exemplary context of a mobile telephone is not the only context and the context may relate to any type of appropriate electronic equipment, examples of which include a media player, a gaming device, and a computer.

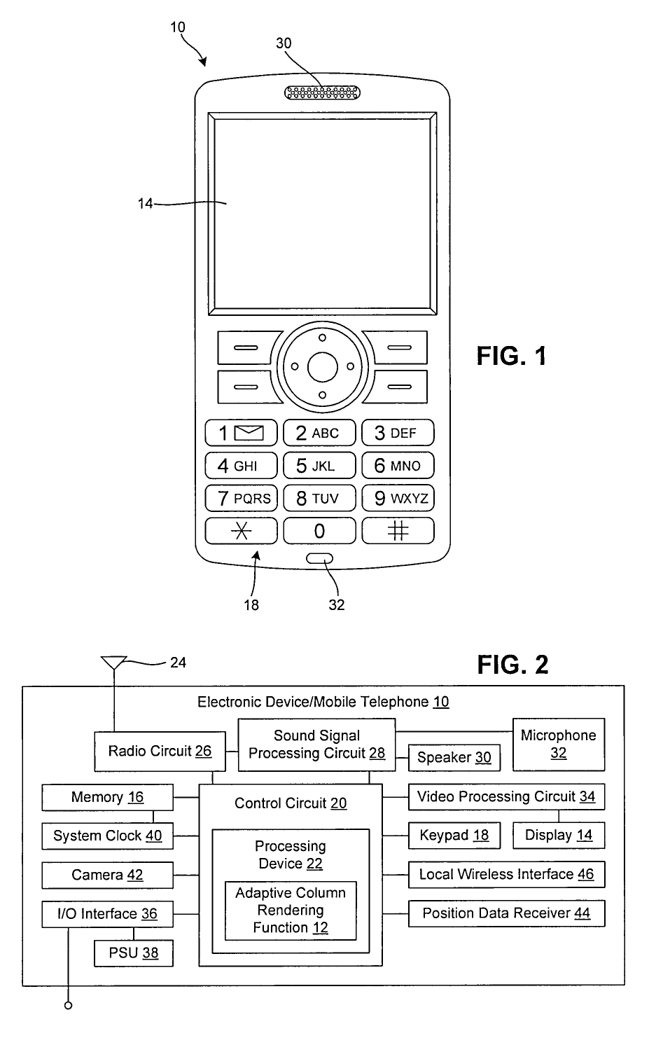

Referring initially to FIGS. 1 and 2, an electronic device is shown. The electronic device 10 includes an adaptive column rendering function 12 that is configured to render web page content by changing column widths, as required for readability, in an adaptive manner that preserves the original layout of the web page as much as possible. Additional details and operation of the adaptive column rendering function 12 will be described in greater detail below. The adaptive column rendering function 12 may be embodied as executable code that is resident in and executed by the electronic device 10. In one embodiment, the adaptive column rendering function 12 may be a program stored on a computer-readable or machine-readable medium. The adaptive column rendering function 12 may be a stand-alone software application or form a part of a software application that carries out additional tasks related to the electronic device 10.

The electronic device of the illustrated embodiment is a mobile telephone and will be referred to as the mobile telephone 10. The mobile telephone 10 is shown as having a “brick” or “block” form factor housing, but it will be appreciated that other housing types may be utilized, such as a “flip-open” form factor (e.g., a “clamshell” housing) or a slide-type form factor (e.g., a “slider” housing).

The mobile telephone 10 includes a display 14. The display 14 displays information to a user such as operating state, time, telephone numbers, contact information, various menus, etc., that enable the user to utilize the various features of the mobile telephone 10. The display 14 also may be used to visually display content received by the mobile telephone 10 and/or retrieved from a memory 16 (FIG. 2) of the mobile telephone 10. The display 14 may be used to present text, images, video, and other graphics to the user, including web page content, mobile television content, photographs, and video associated with games.

A keypad 18 provides for a variety of user input operations. For example, the keypad 18 may include alphanumeric keys for allowing entry of alphanumeric information such as telephone numbers, phone lists, contact information, notes, text, etc. In addition, the keypad 18 may include special function keys such as a “call send” key for initiating or answering a call, and a “call end” key for ending or “hanging up” a call. Special function keys also may include menu navigation and select keys to facilitate navigating through a menu displayed on the display 14. For instance, a pointing device and/or navigation keys may be present to accept directional inputs from a user. Special function keys may include audiovisual content playback keys to start, stop and pause playback, skip or repeat tracks, and so forth. Other keys associated with the mobile telephone may include a volume key, an audio mute key, an on/off power key, a web browser launch key, a camera key, etc. Keys or key-like functionality also may be embodied as a touch screen associated with the display 14. Also, the display 14 and keypad 18 may be used in conjunction with one another to implement soft key functionality.

The mobile telephone 10 includes call circuitry that enables the mobile telephone 10 to establish a call and/or exchange signals with a called/calling device, which typically may be another mobile telephone or landline telephone. However, the called/calling device need not be another telephone, but may be some other device such as an Internet web server, content providing server, etc. Calls may take any suitable form. For example, the call could be a conventional call that is established over a cellular circuit-switched network or a voice over Internet Protocol (VoIP) call that is established over a packet-switched capability of a cellular network or over an alternative packet-switched network, such as WiFi (e.g., a network based on the IEEE 802.11 standard), WiMax (e.g., a network based on the IEEE 802.16 standard), etc. Another example includes a video enabled call that is established over a cellular or alternative network.

The mobile telephone 10 may be configured to transmit, receive and/or process data, such as text messages, instant messages, electronic mail messages, multimedia messages, web page content, image files, video files, audio files, ring tones, streaming audio, streaming video, data feeds (including podcasts and really simple syndication (RSS) data feeds), and so forth. It is noted that a text message is commonly referred to by some as “an SMS,” which stands for short message service. SMS is a typical standard for exchanging text messages. Similarly, a multimedia message is commonly referred to by some as “an MMS,” which stands for multimedia message service. MMS is a typical standard for exchanging multimedia messages. Processing data may include storing the data in the memory 16, executing applications to allow user interaction with the data, displaying text content associated with the data, displaying video and/or image content associated with the data, outputting audio sounds associated with the data, and so forth.

FIG. 2 represents a functional block diagram of the mobile telephone 10. For the sake of brevity, many features of the mobile telephone 10 will not be described in great detail. The mobile telephone 10 includes a primary control circuit 20 that is configured to carry out overall control of the functions and operations of the mobile telephone 10. The control circuit 20 may include a processing device 22, such as a central processing unit (CPU), microcontroller, or microprocessor. The processing device 22 executes code stored in a memory (not shown) within the control circuit 20 and/or in a separate memory, such as the memory 16, in order to carry out operation of the mobile telephone 10. Among other tasks, the control circuit 20 may carry out timing functions, such as timing the durations of calls, generating the content of time and date stamps, and so forth. The memory 16 may be, for example, one or more of a buffer, a flash memory, a hard drive, a removable media, a volatile memory, a non-volatile memory, a random access memory (RAM), or other suitable device. In a typical arrangement, the memory 16 may include a non-volatile memory (e.g., a NAND or NOR architecture flash memory) for long term data storage and a volatile memory that functions as system memory for the control circuit 20. The volatile memory may be a RAM implemented with synchronous dynamic random access memory (SDRAM), for example. The memory 16 may exchange data with the control circuit 20 over a data bus. Accompanying control lines and an address bus between the memory 16 and the control circuit 20 also may be present.

In addition, the processing device 22 may execute code that implements the adaptive column rendering function 12. It will be apparent to a person having ordinary skill in the art of computer programming, and specifically in application programming for mobile telephones or other electronic devices, how to program a mobile telephone 10 to operate and carry out logical functions associated with the adaptive column rendering function 12. Accordingly, details as to specific programming code have been left out for the sake of brevity. Also, while the adaptive column rendering function 12 is executed by the processing device 22 in accordance with an embodiment, such functionality could also be carried out via dedicated hardware or firmware, or some combination of hardware, firmware and/or software.

Continuing to refer to FIGS. 1 and 2, the mobile telephone 10 includes an antenna 24 coupled to a radio circuit 26. The radio circuit 26 includes a radio frequency transmitter and receiver for transmitting and receiving signals via the antenna 24. The radio circuit 26 may be configured to operate in a mobile communications system and may be used to send and receive data and/or audiovisual content. Receiver types for interaction with a mobile radio network and/or broadcasting network include, but are not limited to, global system for mobile communications (GSM), code division multiple access (CDMA), wideband CDMA (WCDMA), general packet radio service (GPRS), WiFi, WiMax, digital video broadcasting-handheld (DVB-H), integrated services digital broadcasting (ISDB), etc., as well as advanced versions of these standards. It will be appreciated that the antenna 24 and the radio circuit 26 may represent one or more than one radio transceiver.

The mobile telephone 10 further includes a sound signal processing circuit 28 for processing audio signals transmitted by and received from the radio circuit 26. Coupled to the sound processing circuit 28 are a speaker 30 and a microphone 32 that enable a user to listen and speak via the mobile telephone 10. The radio circuit 26 and sound processing circuit 28 are each coupled to the control circuit 20 so as to carry out overall operation. Audio data may be passed from the control circuit 20 to the sound signal processing circuit 28 for playback to the user. The audio data may include, for example, audio data from an audio file stored by the memory 16 and retrieved by the control circuit 20, or received audio data such as in the form of streaming audio data from a mobile radio service. The sound processing circuit 28 may include any appropriate buffers, decoders, amplifiers and so forth.

The display 14 may be coupled to the control circuit 20 by a video processing circuit 34 that converts video data to a video signal used to drive the display 14. The video processing circuit 34 may include any appropriate buffers, decoders, video data processors, and so forth. The video data may be generated by the control circuit 20, retrieved from a video file that is stored in the memory 16, derived from an incoming video data stream that is received by the radio circuit 26, or obtained by any other suitable method.

The mobile telephone 10 may further include one or more I/O interface(s) 36. The I/O interface(s) 36 may be in the form of typical mobile telephone I/O interfaces and may include one or more electrical connectors. As is typical, the I/O interface(s) 36 may be used to couple the mobile telephone 10 to a battery charger to charge a battery of a power supply unit (PSU) 38 within the mobile telephone 10. In addition, or in the alternative, the I/O interface(s) 36 may serve to connect the mobile telephone 10 to a headset assembly (e.g., a personal handsfree (PHF) device) that has a wired interface with the mobile telephone 10. Further, the I/O interface(s) 36 may serve to connect the mobile telephone 10 to a personal computer or other device via a data cable for the exchange of data. The mobile telephone 10 may receive operating power via the I/O interface(s) 36 when connected to a vehicle power adapter or an electricity outlet power adapter. The PSU 38 may supply power to operate the mobile telephone 10 in the absence of an external power source.

The mobile telephone 10 also may include a system clock 40 for clocking the various components of the mobile telephone 10, such as the control circuit 20 and the memory 16.

The mobile telephone 10 may include a camera 42 for taking digital pictures and/or movies. Image and/or video files corresponding to the pictures and/or movies may be stored in the memory 16.

The mobile telephone 10 also may include a position data receiver 44, such as a global positioning system (GPS) receiver, Galileo satellite system receiver, or the like. The position data receiver 44 may be involved in determining the location of the mobile telephone 10.

The mobile telephone 10 also may include a local wireless interface 46, such as an infrared transceiver and/or an RF interface (e.g., a Bluetooth interface), for establishing communication with an accessory, another mobile radio terminal, a computer, or another device. For example, the local wireless interface 46 may operatively couple the mobile telephone 10 to a headset assembly (e.g., a PHF device) in an embodiment where the headset assembly has a corresponding wireless interface.

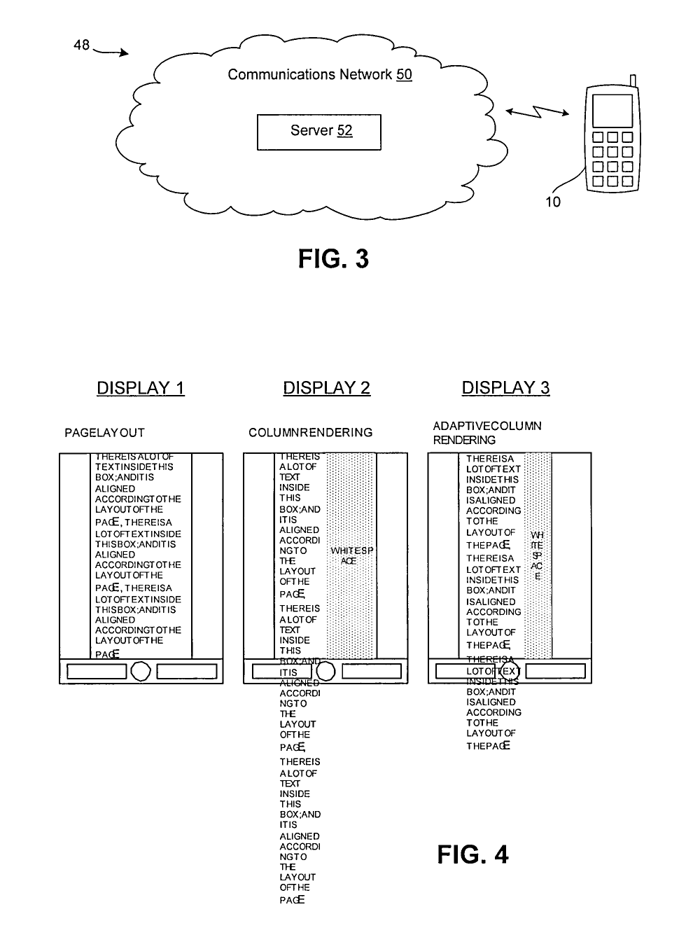

With additional reference to FIG. 3, the mobile telephone 10 may be configured to operate as part of a communications system 48. The system 48 may include a communications network 50 having a server 52 (or servers) for managing calls placed by and destined to the mobile telephone 10, transmitting data to the mobile telephone 10, and carrying out any other support functions. The server 52 communicates with the mobile telephone 10 via a transmission medium. The transmission medium may be any appropriate device or assembly, including, for example, a communications tower (e.g., a cell tower), another mobile telephone, a wireless access point, a satellite, etc. Portions of the network may include wireless transmission pathways. The network 50 may support the communications activity of multiple mobile telephones 10 and other types of end user devices. As will be appreciated, the server 52 may be configured as a typical computer system used to carry out server functions and may include a processor configured to execute software containing logical instructions that embody the functions of the server 52 and a memory to store such software.

As noted herein, a web page is often designed for display on a personal computer, which may have a screen or monitor size in a range, for example, of around 10 inches (e.g., laptop screen) to 24 inches (e.g., desktop monitor) or larger, measured diagonally. Portable electronic devices, including mobile telephones, may have screen sizes as small as, for example, around one or two inches. As discussed, the mobile telephone 10 is capable of receiving, processing, and displaying web page content on the display 14. In order to preserve as much of the original appearance of the web page as possible when displayed on a small screen, such as the display 14, the mobile telephone 10 utilizes the adaptive column rendering function 12.

FIG. 4 shows three different exemplary displays of the same sample web page content. The web page has three columns and sample text in the center column. All three displays show the content in a zoomed-out view. DISPLAY 1 of FIG. 4 shows the text in its original web page layout, with an original column width. DISPLAY 2 shows the text after a conventional column rendering function has been applied to the center column. As shown, this may result in a narrower and consequently longer column, for example, to improve the readability of the text after the device zooms in on the column. The rendering function changes the column width in anticipation of a zoom-in view, such that, after the device zooms in on the column, the amount of side-to-side scrolling necessary to read the text is minimized. The text shown continuing below the viewable portion of the display represents text that would be viewable after scrolling down. Unwanted white space may be created when the text column width is narrower than another component of web page content that shares the column space and requires a fixed width wider than the text.

DISPLAY 3 shows the same text after the adaptive column rendering function 12 has been applied. The adapted column width is narrower and longer than the original column, but not as narrow or long as the column in DISPLAY 2. Instead of adjusting the column width based on a fixed zoom factor for the zoom-in view, the adaptive column rendering function 12 determines the actual text size in the column and utilizes varying levels of zoom to make it readable. This allows the adaptive column rendering function 12 to minimize the amount of zoom and column narrowing necessary to achieve readable text. White space may also be minimized when other content requires a wider fixed width. As a result, adapted column widths allow the rendered web page to maintain an appearance closer to the original layout.

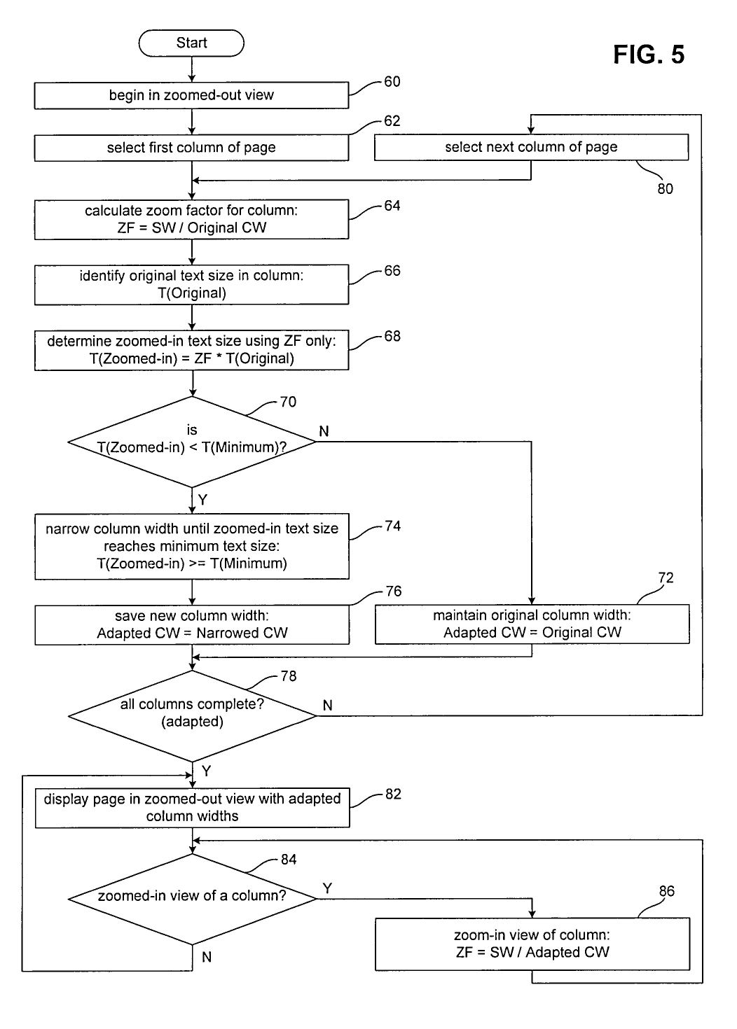

With additional reference to FIG. 5, illustrated are logical operations to implement an exemplary method for displaying web page content on the mobile telephone 10. The exemplary method may be carried out by executing an embodiment of the adaptive column rendering function 12, for example. Thus, the flow chart of FIG. 5 may be thought of as depicting steps of a method carried out by the mobile telephone 10. Although FIG. 5 shows a specific order of executing functional logic blocks, the order of executing the blocks may be changed relative to the order shown. Also, two or more blocks shown in succession may be executed concurrently or with partial concurrence. Certain blocks also may be omitted. In addition, any number of functions, logical operations, commands, state variables, semaphores, or messages may be added to the logical flow for purposes of enhanced utility, accounting, performance, measurement, troubleshooting, and the like. It is understood that all such variations are within the scope of the present invention.

The logical flow for the adaptive column rendering function 12 may begin in block 60 where the mobile telephone 10 starts rendering web page content in a zoomed-out view on the display 14. The web page may include, for example, text, images, tables, or other content, or any combination thereof. The web page content may also be organized in one or more columns. For example, a web page may be organized in three columns: a column on the left, which may be a menu; a larger column in the center for text; and a column on the right for advertisements or other content. In other examples, the web page may have one or more columns of only text, alternating columns of text and images, columns with combinations of text and images, etc. Regardless of web page content, the adaptive column rendering function 12 follows the same process to adapt the columns based on the text appearance in the columns.

Proceeding to block 62, the adaptive column rendering function 12 selects the first column of the page to adapt. The first column may be the leftmost column of a web page, but may also be any other column of the web page. For example, the adaptive column rendering function 12 may prioritize the sequence of columns for adaptation based on their content, location, or any other attribute.

Proceeding to block 64, the adaptive column rendering function 12 calculates an initial zoom factor for the column. The zoom factor (ZF) is the multiplier used for zooming in on a column. Since the adaptive column rendering function 12 utilizes varying levels of zoom, not a fixed zoom rate, the zoom factor may be different for each column. The zoom factor for any column can be equal to the screen width (SW) divided by the column width (CW). For example, if a column width is one inch and the screen width is two inches, then the zoom factor would be equal to two, i.e., the column would be magnified by two times (2×) during a zoom-in view. As a result, the zoom factor enlarges the column to fit the screen width during a zoom-in view. In this manner, the column and text within the column are expanded (zoomed-in on) as much as possible before side-to-side scrolling would be necessary to view the column. Side-to-side scrolling may be implemented when the column is wider than the screen.

Next, the adaptive column rendering function 12 may proceed to block 66 to identify the original text size in the column. In one embodiment, the adaptive column rendering function 12 searches for the smallest font in the column. In other embodiments, the adaptive column rendering function 12 may search for the smallest font with a minimum number of characters, calculate an average text size, calculate a weighted average text size, or any other method used to represent the original text size in the column. The original text size is identified before any zoom is applied to the column.

Proceeding to block 68, the adaptive column rendering function 12 determines the zoomed-in text size using the zoom factor. The zoomed-in text size is equal to the zoom factor (from block 64) times the original text size (from block 66). This step determines what the text size would be on the display 14 after zooming-in using the zoom factor. More specifically, it determines how big the text would be, on the display 14 of the mobile telephone 10, if the original column width were expanded (zoomed-in on) to fit the width of the screen.

Proceeding to block 70, the adaptive column rendering function 12 determines whether the zoomed-in text size (from block 68) is less than a minimum text size. The minimum text size is a reference text size to represent the smallest size text that the adaptive column rendering function 12 treats as readable. The minimum text size may vary by language, font type, case (lower versus upper), style (bold, italics, underline, etc.), text color, background color, highlighting, any other attribute, or any combination thereof.

If the zoomed-in text size is greater than or equal to the minimum text size in block 70, the logical flow may proceed to block 72 where the adaptive column rendering function 12 maintains the original column width as the adapted column width. Since the zoomed-in text size of the column is at least as large as the minimum text size, column narrowing is not necessary. When the user chooses to zoom in on the column, the adaptive column rendering function 12 will zoom in using the zoom factor for the column, such that the zoomed-in column width will equal the screen width of the display 14. Without narrowing, the column will not become longer than the original column and unwanted white space will not be created adjacent to the column. The column will appear on the mobile telephone 10 in the same manner as it was designed to appear in the original web page layout.

If the zoomed-in text size is less than the minimum text size in block 70, the logical flow may proceed to block 74 where the adaptive column rendering function 12 narrows the column width until the zoomed-in text reaches the minimum text size. The zoom factor (ZF) for any column is equal to the screen width (SW) divided by the column width (CW). When the column width is narrowed, the zoom factor for the column increases. The zoomed-in text size is equal to the zoom factor times the original text size. As the zoom factor increases, the zoomed-in text size increases. Therefore, by combining these relationships, as the column width is narrowed, the zoomed-in text size increases. In block 74, the adaptive column rendering function 12 narrows the column width until the zoomed-in text size is greater than or equal to the minimum text size. During this process, the zoom factor is re-calculated, the zoomed-in text size is re-determined, and the zoomed-in text size is re-compared to the minimum text size. In this manner, the column is only narrowed to the extent required to make the zoomed-in text readable, unlike a fixed zoom or rendering function that may result in columns narrower than necessary. As a result, column lengthening and unwanted white space are also minimized.

Proceeding to block 76, the adaptive column rendering function 12 saves the narrowed column width as the adapted column width. With the narrower column width, the zoomed-in text size of the column is at least as large as the minimum text size. When the user chooses to zoom in on the column, the mobile telephone 10 will zoom using the re-calculated zoom factor for the column, such that the zoomed-in column width will equal the screen width of the display 14.

Proceeding to block 78, from either block 72 or block 76, the adaptive column rendering function 12 determines whether all columns of the web page have been completed. The web page content may include one or more columns. The adaptive column rendering function 12 determines an adapted column width for each column of the web page independently. The adapted column widths and zoom factors for each of the columns may be different.

If all columns of the web page have not been completed in block 78, the logical flow may proceed to block 80 where the adaptive column rendering function 12 selects the next column of the web page. The adaptive column rendering function 12 may prioritize the sequence of columns for adaptation based on their content, location, or any other attribute. After selecting the next column of the web page, the logical flow may proceed to block 64 where the adaptive column rendering function 12 calculates an initial zoom factor for the next column and proceeds accordingly.

If all columns of the web page have been completed in block 78, the logical flow may proceed to block 82 where the adaptive column rendering function 12 displays the web page in a zoomed-out view with the adapted column widths. An example of a zoomed-out view of a web page with an adapted column width is shown in FIG. 4, DISPLAY 3. As described earlier, the adaptive column rendering function 12 displays a rendered web page with an appearance closer to the original layout than a process that utilizes non-adaptive rendering, for example, with fixed zoom factors or fixed column widths.

Proceeding to block 84, the adaptive column rendering function 12 determines whether the user has chosen a zoomed-in view of a column. If the user has not chosen a zoomed-in view of a column in block 84, the logical flow proceeds back to block 82 where the adaptive column rendering function 12 continues to display the web page in a zoomed-out view.

If the user has chosen a zoomed-in view of a column in block 84, the logical flow may proceed to block 86 where the adaptive column rendering function 12 zooms in on the chosen column. The adaptive column rendering function 12 will display the zoomed-in column on the display 14 where the zoom factor of the column is equal to the screen width divided by the adapted column width. Because the adapted column width and zoom factor were determined based on the zoomed-in text size, the text in the zoomed-in column will be readable.

After zooming-in on a column in block 86, the logical flow may proceed back to block 84 where the adaptive column rendering function 12 determines whether the user has chosen a zoomed-in view of another column and proceeds accordingly.

The adaptive column rendering function 12 renders all of the columns of the web page as soon as the web page is displayed by the mobile telephone 10 in a zoomed-out view, before the user chooses to zoom in on any one column. Laying-out the web page once avoids the processing time and power necessary to re-render a web page or a column every time a user chooses to zoom in on or out of a particular column of the web page.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Computer program elements of the invention may be embodied in hardware and/or in software (including firmware, resident software, micro-code, etc.). The invention may take the form of a computer program product, which can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method for displaying web page content on an electronic device, the web page content including at least one column of text, comprising:
calculating a zoom factor for the at least one column;
determining a text size in the at least one column based on the zoom factor;
comparing the determined text size to a reference text size; and
changing a column width of the at least one column if the determined text size is less than the reference text size.

2. The method of claim 1, wherein changing the column width of the at least one column includes narrowing the column width until the determined text size is greater than or equal to the reference text size, including:
re-calculating the zoom factor for the at least one column;
re-determining the text size in the at least one column based on the zoom factor; and
re-comparing the determined text size to the reference text size.

3. The method of claim 2, wherein determining the text size in the at least one column based on the zoom factor includes searching for a smallest font in the at least one column of text and using the smallest font to determine the text size.

4. The method of claim 2, further comprising displaying the web page content in a zoomed-out view, wherein a plurality of columns of text are viewable on a screen of the electronic device.

5. The method of claim 4, further comprising displaying the at least one column of text in a zoomed-in view based on the zoom factor.

6. The method of claim 5, wherein the screen is a display of a mobile radio terminal.

7. A program that displays web page content on an electronic device, the web page content including at least one column of text, and is embodied on a computer-readable medium, the program comprising executable logic to:
calculate a zoom factor for the at least one column;
determine a text size in the at least one column based on the zoom factor;
compare the determined text size to a reference text size; and
change a column width of the at least one column if the determined text size is less than the reference text size.

8. A mobile radio terminal, comprising:
a radio circuit for establishing calls; and
a control circuit that carries out logical instructions to display web page content on a display of the mobile radio terminal, the web page content including at least one column of text, the control circuit including:
logic that calculates a zoom factor for the at least one column;
logic that determines a text size in the at least one column based on the zoom factor;
logic that compares the determined text size to a reference text size; and
logic that changes a column width of the at least one column if the determined text size is less than the reference text size.

9. The mobile radio terminal of claim 8, wherein logic that changes the column width of the at least one column includes logic that narrows the column width until the determined text size is greater than or equal to the reference text size, including:
logic that re-calculates the zoom factor for the at least one column;
logic that re-determines the text size in the at least one column based on the zoom factor; and
logic that re-compares the determined text size to the reference text size.

10. The mobile radio terminal of claim 9, wherein logic that determines the text size in the at least one column based on the zoom factor includes logic that searches for a smallest font in the at least one column of text and logic that uses the smallest font to determine the text size.

11. The mobile radio terminal of claim 9, wherein the control circuit further includes logic that displays the web page content in a zoomed-out view, wherein a plurality of columns of text are viewable on the display of the mobile radio terminal.

12. The mobile radio terminal of claim 11, wherein the control circuit further includes logic that displays the at least one column of text in a zoomed-in view based on the zoom factor.
